(19) United States
(12) Patent Application Publication
(10) Pub. No.: US 2002/0056009 A1
(43) Pub. Date: May 9, 2002

(54) Method for interacting with a device using an abstract space

(76) Inventors: Filippo L. Affif, Menlo Park, CA (US); David C. Robb, Menlo Park, CA (US)

Correspondence Address: Henneman & Saunders, 121 E. 11th Street, Tracy, CA, 95376, US

(21) Appl. No.: 09/935,058

(22) Filed: Aug. 21, 2001

Related U.S. Application Data
(60) Provisional application No. 60/227,138, filed on Aug. 22, 2000.
(60) Provisional application No. 60/250,821, filed on Dec. 1, 2000.

(51) Int. Cl. G06F 15/16

(52) U.S. Cl. 709/246

(57) ABSTRACT

A web interface method (300) incorporating a system for communicating between devices (10 and a method for communicating between devices (200) wherein a user interacts with objects (306) in an abstract space (302). Results of the interaction are interpreted in an abstract language (18) and then translated to a universal language (20) such that input devices (12, 14) are independent of the specific type of device (12, 14) with which they might be interacting. Communication of the universal language (20) can optionally be over the Internet (22).

### RELATIONSHIP TO PRIOR APPLICATIONS

Priority is hereby claimed to U.S. Provisional Application Serial No. 60/227,138 entitled SYSTEM AND METHOD FOR INTERACTING WITH AN ABSTRACT SPACE, which was filed on Aug. 22, 2000. Priority is also claimed to U.S. Provisional Application Serial No. 60/250,821 entitled UNIVERSAL WEB INTERFACE, STRUCTURE, OPERATIONS, APPLICATIONS, which was filed on Dec. 1, 2000. Both priority applications are incorporated herein by reference in their entirety.

### TECHNICAL FIELD

The present invention relates to the field of computer/user interface and machine input devices and methods, and more particularly to methods and apparatus for interaction with an abstract representation medium, so as to effect choices, express degree of preference, select among alternatives, establish boundaries and thresholds and such other actions as are desired. The predominant current usage of the inventive interaction method is in the control and interaction with machines as computers and other computer controlled devices.

### BACKGROUND ART

It is known in the art to use input devices such as to indicate an action desired by a user in a manner such as the positioning of a mouse directed pointer in a designated selection area of a computer screen and then “clicking” on the selection by depressing a keyswitch. This input is translated in to a device specific message which is sent to the host system. Each input modality generates its own set of messages which must be “understood” by the host, and several different messages could result in the same action by the host. While this is a powerful and widely used method for interaction, it is often highly specific to a particular input modality or device, and limited, particularly when extended to other domains.

Also, while conventional input means and methods such as using a mouse to click on a desired menu selection is often very useful, it can also be limiting in that the user's choices are limited by the menu selections, choice of icons, or the like. It would be useful to have a more general and intuitive method for allowing the user to interact with a computer or other digitally controlled device.

It would likewise be beneficial to have a device interaction method which could be understood by machines regardless of the particular operating system and other characteristics of the machine. Such a method would be useful in that the user need not familiarize himself with a particular method for operating each particular machine. Indeed, the user would not even need to know the exact nature of the machine with which he is interfacing. Such a method could provide a useful interface through an internet connection, a telephone connection, or through essentially any medium. The interaction could take place essentially directly between a machine and a user, or it could be channeled through intermediate machines, intermediate communications media, and the like.

To the inventors' knowledge, all prior methods and means for interaction with a computerized device have depended upon programming or “teaching” the device to perform a particular action upon the receipt of a particular user input, or else translating the specific input into a specific language usable by the device. To the inventors' knowledge, there remains much room for the improvement of the computer/user interface, in that inherent choice limitations and option restrictions exist in all known prior art methods and means.

### DISCLOSURE OF INVENTION

Briefly, a known embodiment of the present invention includes interaction is through an input language which is particularly organized to work with an abstract representation medium. The input language is then translated into a universal language which will interact with and/or control a computer or computerized device.

The abstract language will accept common user inputs, such as “mouse” operations, voice commands, gestures, or other inputs, using operations with predefined meaning within a predefined space of a medium. Many different inputs may translate to the same common language element. The input language forms an interface to the space (representation medium). For example, a gesture might be a motion of the hand, as in sign language, or auditory, as a whistle, or eye motion tracked with an eye tracking system, or any other deliberate action within the space, yet each could be translated into the same universal language element which could be an indication of a choice.

Inputs and outputs can be mediated, so that an input with a motion tracking device such as an accelerometer equipped pen, or by means of a mouse or trackball, or by any other human directed device should be included within the scope of the invention. Inputs and outputs may also include motion and placement of symbolic objects, such as graphic forms, pointers, boundary markers, variously shaped graphic cursors, auditory tones or chords, or any other appropriate object within the abstract space.

The methods and means described herein can be applied to the current screen based environments, but also lend themselves well to other domains such as eyes-busy mobile applications and multi-dimensional interactive domains.

Another aspect of the invention which is complementary to the abstract language elements is the structure of the abstract space. The space may have predefined structure which may be linear or planar, but may also be multidimensional in any of the sensory modalities. A three dimensional acoustic space could be defined, for example where pitch, tempo, and volume could be the defining Cartesian axes of the space. Various regions of this space could have predefined meaning so that motion into that region would restrict and define the meaning of operations or inputs made in that region. For example, a portion of abstract space defined as three left steps and one down step from a home position in the space accessed by a telephone keypad could mean email access. Once in that region, other inputs could select composition of a new message, text to speech translation of written messages for auditory presentation (reading the mail), among others.

Another aspect of the invention is feedback to the user in a form suitable to the medium and the actions or decisions taken within the medium. One form of feedback would be to change the shape, color, or other aspect of a graphic object on a screen to indicate the selection or action taken. Voice annunciation of the region function when entering into a new acoustic based region would be another feedback mechanism.

The particular input from the input device or modality will be translated into one or more specific abstract language elements and would be communicated to an appropriate server which could be local or remote. The temporal and spatial structure and sequence of the language elements would be evaluated to determine if a particular input or operation was performed, The language element(s) would be associated with information stored in the server which would indicate objects or regions within the abstract space to which the elements referred. The hypothetical element would be evaluated against the permitted actions for that region or object and appropriate feedback presented. Valid elements would result in the appropriate action, which may include sending messages to other destinations, changing the structure of the abstract space, or other actions. An example of one instance of the medium might be a web page displayed in an internet browser window. The desired interaction might then be selection of an item displayed in the page.

The methods and means described herein can be applied to the current screen based environments, but also lend themselves well to other domains such as eyes-busy mobile applications and multi-dimensional interactive domains. For example, in a gesture based system such as a graphic tablet, the intention of the user is expressed by deliberate motion, such as would not be produced by ordinary motion through the space. Such motion could include gestures such as a circling or “checking” motion, motion along a constrained path, motion crossing defined boundaries, or traversal of a multi-dimensional grid in a particular pattern. Particular translation means would recognize each gesture, and translate the result into a universal language description. The language is independent of the particular medium, and expresses operations, commands, object descriptions and other relevant nouns, verbs, and modifiers with specific meaning shared by all interpreters of the language. The system server need only “understand” this language, whereas the intermediate translators need only translate between this language and the devices and modalities to which they are specific.

The inventive method of input and output is universal, and operates in multi-dimensional space where the number of dimensions is at least one, it is possible to construct and use in the selection process N-dimensional objects. The particular design of an N-dimensional object is a significant part of defining the space for selections. As an example, a 3-space (3D) polyhedron could form the selection space in a virtual reality situation. Commands effecting traversal through a particular face of the polyhedron could be used to indicate selection of the alternative represented by that face. Likewise, a circling gesture around a particular vertex could select an action associated with that vertex. Velocity of traversal or circling would indicate the “strength” of the selection. Universal language elements would exist to describe selection, magnitude, location relative to an object, and other relevant information. The gestural inputs would be translated into the universal language elements which would then be communicated to the server (host).

The abstract space may be augmented by use of “cursors” of particular shapes, colors, auditory tones, or other forms appropriate to the selection space. Cursors could be “picked up” or “put down” by gestures or switch selection associated with the particular pointing technology, such as switch closure on a computer mouse. Each cursor form would indicate a particular action to be performed by that cursor, such as select, deselect, modify, or other action. Again, universal language elements would express the particular operations on objects, but the translator for the display controller associated with the abstract space, and with the input modality would translate the commands and objects into appropriate form.

As a universal interface, the present invention does not rely on a particular interaction paradigm, such as the current visual presentation of information on a computer screen, but instead offers the ability to translate as well as mediate between modalities such as text to voice, key selections instead of mouse “clicks”, and many other intermodal translations in the access process. Further, devices with limited interaction capabilities are accommodated through proper presentation of information and choices so as to make effective use of such capabilities as do exist, as well as capabilities which can be created in the future or combined in new forms.

In the prior art, the burden of translation has been placed on the website developers. Furthermore, the effort of maintenance has increased manyfold, and is proportional to the number of different standards and protocols supported. In addition, not all websites will undertake the translation effort so that access through a particular device is restricted to only those sites which have implemented the requisite access protocol.

An advantage of the present invention is that a user is not restricted to predetermined input choices.

A further advantage of the present invention is interaction with a computerized device is intuitive.

Yet another advantage of the present invention is that interaction with a computerized device can be independent of the type of device.

Still another advantage of the present invention is that a user can more readily control and/or interact with a computer controlled device.

Yet another advantage of the present invention is that server systems can be devised which do not rely on information about the particular input or output modalities.

Still another advantage of the present invention is that new input and output modalities can be added without changing the host system to accommodate them.

Still another advantage of the present invention is that abstract spaces which have common and familiar structure can be defined for many different media so that users can transfer skills to perform similar operations even though the spaces are significantly different in form.

Yet another advantage of the present invention is that a universal language can be widely shared without disclosing proprietary methods of input, output, or translation.

Still another advantage of the present invention is that an object can be selected by moving in relation to that object.

Yet another advantage of the present invention is that web site developers can easily configure their web sites to interact with a great variety of remote devices.

These and other objects and advantages of the present invention will become clear to those skilled in the art in view of the description of modes of carrying out the invention, and the industrial applicability thereof, as described herein and as illustrated in the several figures of the drawing. The objects and advantages listed are not an exhaustive list of all possible advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the above described objects and advantages. Accordingly, the listed advantages are not essential elements of the present invention, and should not be construed as limitations.

### BRIEF DESCRIPTION OF THE DRAWINGS

FIG. 1 is diagrammatic representation of a system for communicating between devices according to the present invention;

FIG. 2 is a computer system such as might be used to practice the invention;

FIG. 3 is a flow diagram depicting the operation of the system for communicating between devices of FIG. 1;

FIG. 4 is a flow chart depicting an example of the present inventive method for constructing a web interface according to the present invention;

FIG. 5 is a representation of an abstract space such as might be created and used according to the present invention;

FIG. 6 is another example of an abstract space, similar to FIG. 5;

FIG. 7 is yet another example of an abstract space, similar to those of FIGS. 5 and 6;

FIG. 8 is still another example of an abstract space, according to the present invention;

FIG. 9 is an example of still another abstract space;

FIG. 10 is a flow diagram depicting an example of the primary substeps of the input operation of FIG. 4; and

FIG. 11 is a diagrammatic view of an alternate configuration of the present inventive system.

### DETAILED DESCRIPTION OF THE INVENTION

This invention is described in the following description with reference to the Figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage devices such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution. The method form of the invention may be practiced by combining one or more machine readable storage devices containing the code according to the present invention with appropriate standard computer hardware to execute the code contained therein. An apparatus for practicing the invention could be one or more computers and storage systems containing or having network access to computer program(s) coded in accordance with the invention.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

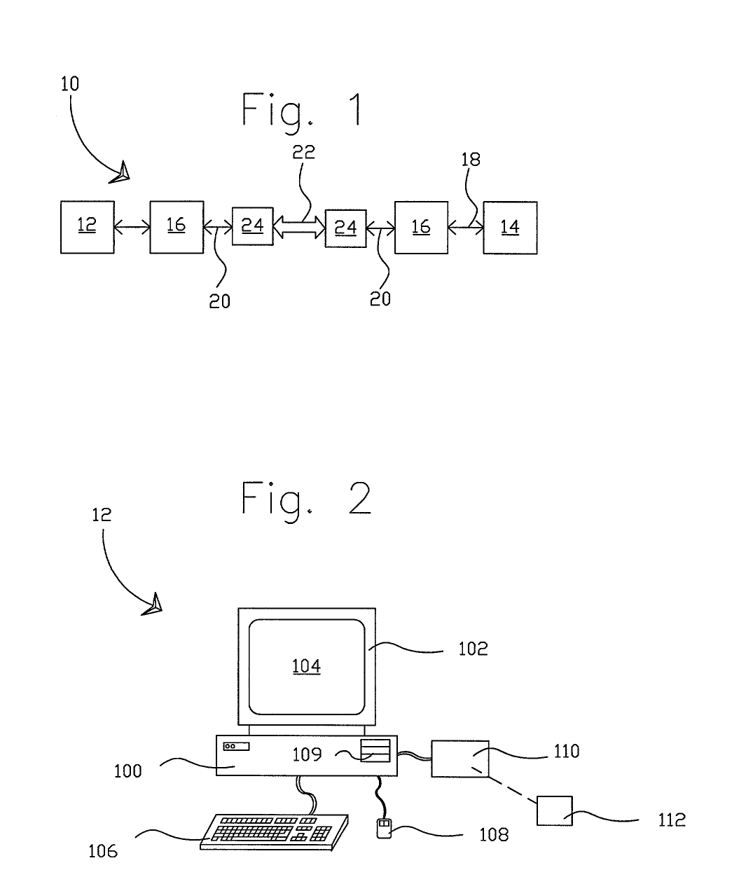

A known mode for carrying out the invention is a system for communicating between devices. The system for communicating between devices is depicted in a diagrammatic view in FIG. 1 and is designated therein by the general reference character 10. The system for communicating between devices, as depicted in FIG. 1, may be implemented in whole or in part according to the present inventive method, and parts of the system 10 can be used separately and/or independently from other parts according to the inventive method as described herein. According to the present invention, the system for communicating between devices 10 has a first device 12 and a second device 14, which will be discussed in greater detail hereinafter. Associated with each of the devices 12 and 14 is a universal language translator 16 for converting an abstract language 18 output from the device into a universal language 20, and further for translating the universal language 20 into the abstract language 18 for input the respective devices 12 and 14. According to the present invention, the universal language 20 is communicated between the universal language translators 16. In the present example, the universal language 20 is communicated across the internet 22, although it is within the scope of the invention that the universal language 20 can be transmitted between the universal language translators 16 directly or through some other medium. However, in the example shown wherein the universal language 20 is transmitted across the internet 22, a web interface device 24 will be associated with each universal language translator 16 for modifying the universal language 20 into a form acceptable for transmission over the internet 22. For example, the action of the web interface devices 24 might be as simple as adding html headers, and the like, so that the universal language 20 can be transmitted across the internet 22. It should be noted that the web interface devices 24 and/or the universal language translators 16 can be incorporated into the same hardware (such as a computer) which is the device 12 and/or 14. Alternatively, it is within the scope of the invention that the universal language translators 16 and/or the web interface devices be remote from the devices 12 and/or 14. Indeed, it is anticipated that different applications of the present invention will find the hardware for performing the functions described herein being accessed via the internet 22 or the like. That is, the utility of the invention does not depend upon the relative physical location of the hardware used to accomplish the inventive methods.

According to the present invention, a user will interact with one of the devices 12 or 14 through a web interface to produce an output in the abstract language 18. The abstract language 18 is converted to the universal language 20 in the universal language translator 16 and the universal language is communicated to the other universal language translator 16 for conversion to the abstract language 18 which is, in turn, communicated to the other of the devices 12 or 14. It should be noted that the example of FIG. 1 is a simple example and only one of many configurations in which the present invention might be employed. For example, the quantity of devices 12 or 14 might be more than two. Another example of a variation might be that communications need not necessarily be bi-directional as indicated in the example of FIG. 1.

It should be noted that the two examples of the abstract language 18 depicted in the example of FIG. 1 need not necessarily be the same. The abstract language 18 can be specific to the device 12 or 14 and/or the particular application. Indeed, it is one aspect of the present invention that the quantity of translator programs or programming required to interconnect the devices 12 and 14 is greatly reduced. For example, where a quantity of different type devices (not shown) were to be interconnected, such that ten different devices were to be on one end of the communication and 10 devices on the other end, then in the prior art there would be required 100 different translator routines to communicate between all of such devices. However, using the universal language translators 16 to convert the outputs and inputs from and to each of the devices 12 and 14 the universal language 18 means that a maximum of twenty such routines might be required, even assuming that all twenty of the examples of the devices 12 and 24 were different from each other.

It should be noted that all of the universal language translators 16 need not know the entire universal language set. Indeed, in the simplest case, where one of the devices 12 or 14 is a simple machine which can only be turned on or off, the associated universal language translator 16 need only know how to translate enough of the universal language 20 to translate such simple commands.

FIG. 2 is an example of a computer system such as might be used as the device 12. It should be noted that this is but one of a great number of devices, both existing and yet to be developed, which might be so used. As but a few of the many examples, the device 12 could alternately be a telephone input and output device, a three dimensional input and output device, or the like. In this present example, the device 12 has a computer 100 with a monitor 102 having a display screen 104 thereon. This example of the device 12 has input devices including a keyboard 106 and a mouse 108. The device 12 has an internal memory device 109 for storing the code necessary or desirable to practice at least some aspects of the present invention and, optionally, an external storage device 110. A removable media 112 is capable of storing some or all of the code for practicing the invention thereon such that the code can be transported and/or transferred to other such devices (not shown).

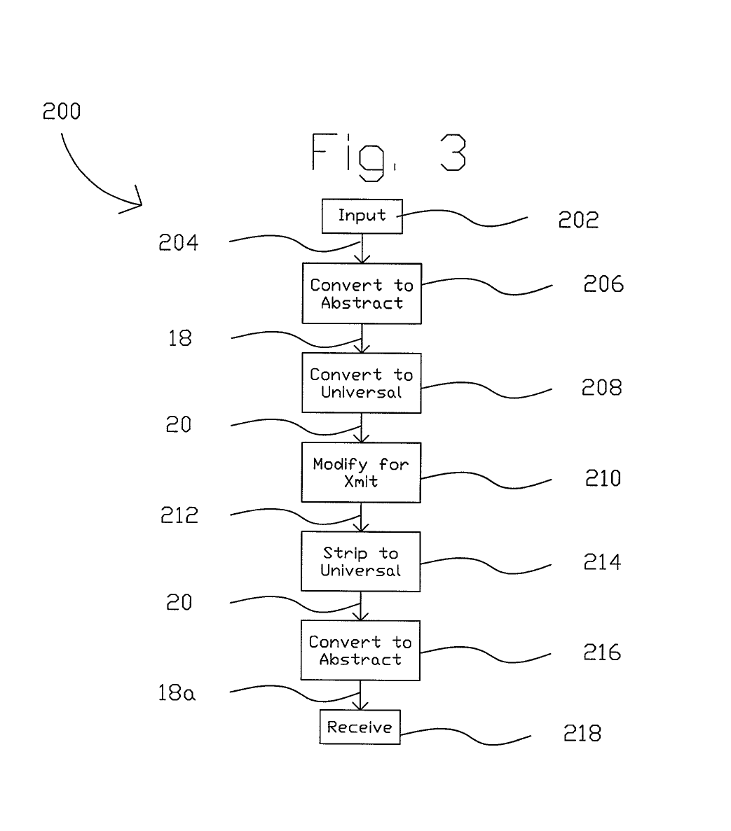

FIG. 3 is a flow diagram depicting a method for communicating between devices 200 using the system for communicating between devices 10 of FIG. 1. According to the example of FIG. 3, the method for communicating between devices has an input operation 202 wherein a user interacts with a device (the device 12, in this present example), to indicate the intentions of the user. The input operation 202 will be discussed in greater detail hereinafter. The input operation is communicated, generally within the device 12, to indicate the action which the user has taken. As will be discussed hereinafter, such action might consist of any of a great number of actions. Such input is communicated in an input language 204 and converted to the abstract language 18 (FIG. 1) in a convert to abstract language operation 206. The abstract language 206 will be an interpretation of the actions of the user from the input language 204 operations to an expression of the user's intentions.

In a convert to universal language operation 208 the abstract language 18 is converted to the universal language 20. As previously discussed herein, the universal language 20 is independent of the particular device 12, and of the medium and any intermediate devices through which the universal language 20 might be transmitted. It is also independent of the particular action which the user is attempting to initiate which, in this particular example, is a communication with and/or control of the other device 14.

In a modify universal language for transmission operation 21 the universal language 20 is modified such that it can be communicated in a particular medium or manner. For example, if the universal language 20 is intended in this instance to be communicated across the internet, then it could be wrapped in HTML code, or the like/ As previously discussed, this operation is optional and dependent upon the means and method by which it is intended to transmit or communicate the universal language 20.

Where, as in this present example, the object is to communicate with the second device (FIG. 1), the universal language 20 is “stripped” back to its earlier form in a strip to universal language operation 214. In a reconvert to abstract language operation 216, the universal language is then translated to a second abstract language 18a, as previously discussed herein in relation to FIG. 1. It should be noted that this example uses the second abstract language 18a to indicate the fact that the second abstract language 18a is specific to the second device 14. There is certainly no prohibition that the second abstract language 18a might be the same as the first abstract language 18, where the second device 14 is of a type which could utilize the first abstract language 18. A receive operation 218 indicates reception of the second abstract language 18a by the second device 14, whereupon the action requested, or the like, is accomplished by the second device 14. It should be noted that the flow diagram of FIG. 3 describes a unidirectional communication. In many instances, upon the accomplishment of the receive operation 218, the second device 14 will provide feedback or a response to the user at the first device 12, whereupon the operations of the method for communicating between devices 200 described in relation to FIG. 2 will be accomplished again with communications flowing from the second device 14 to the first device 12.

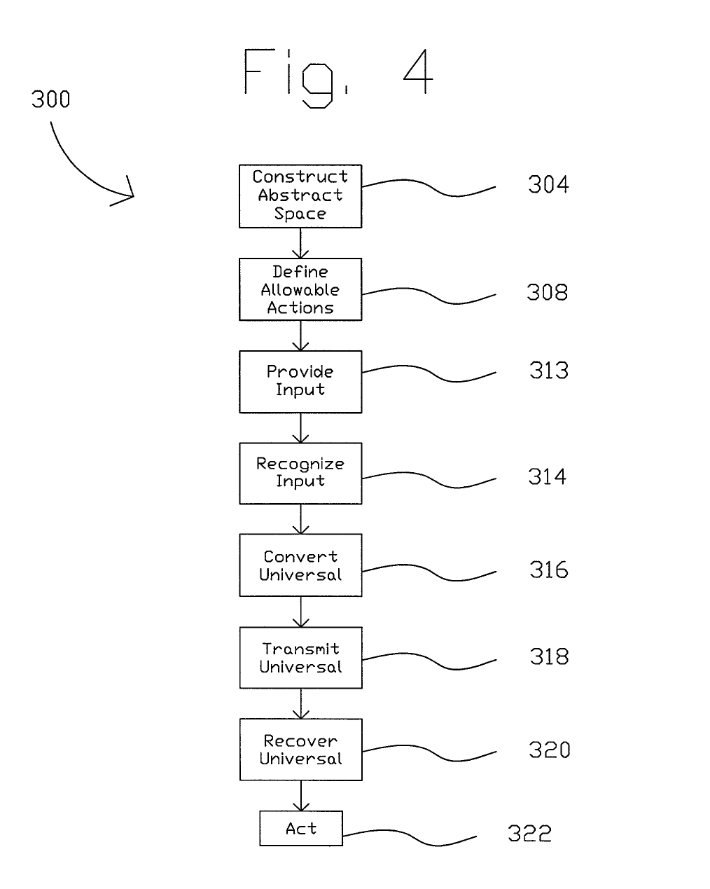

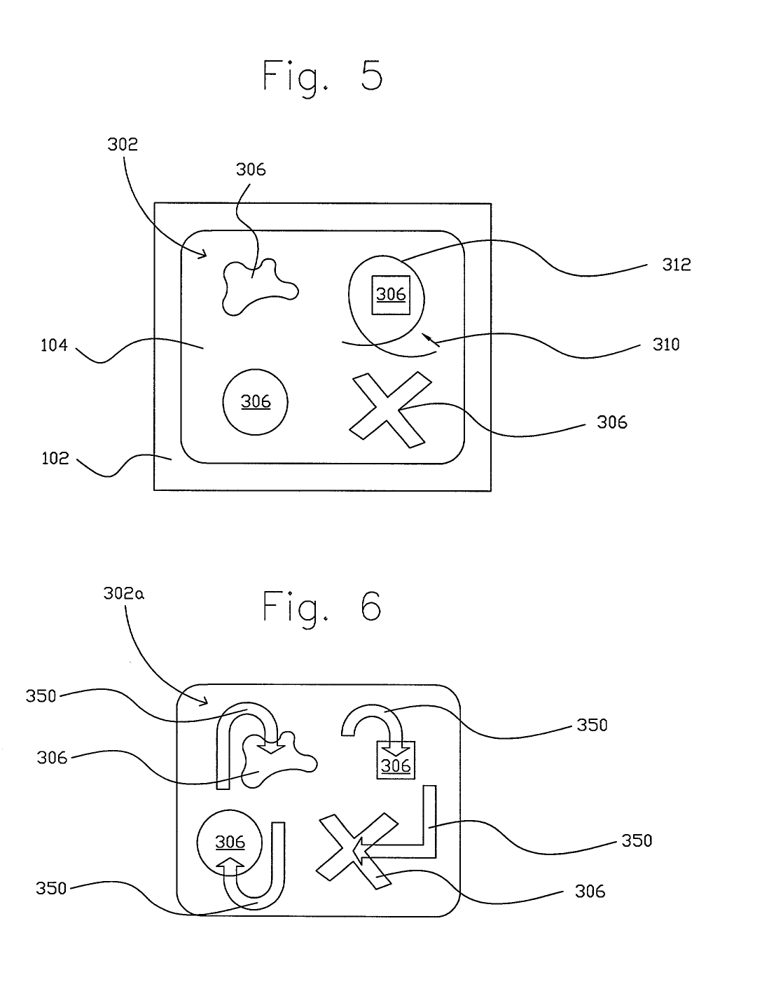

It is an aspect of the present invention that the input operation 202 can be accomplished using a potentially great variety of different types of device 12 and/or 14, and that such input will involve a very intuitive and easy interaction between the user and the device 12 or 14. FIG. 4 is flow diagram depicting an example of a method 300 for constructing and using a web interface according to the present invention. FIG. 5 is a depiction of a particular example of the computer screen 104 of FIG. 2 showing just one of many possible examples of an abstract space 302 displayed thereon, as will be discussed in conjunction with the method of FIG. 4, hereinafter. As will be discussed in greater detail hereinafter, in the example of FIG. 5, a screen object can selected by drawing a continuous path around it. Note that no click event is required to effect the selection. The translation means would recognize the selection gesture predefined for this input medium and organization, and would generate a universal language 20 “paragraph” which would indicate that the appropriate element in the object list was selected. The “paragraph” could then be sent to a server, or the like, which would determine what action, if any, was to be taken in response to the event. Other possible examples (not shown) of an abstract space might include an auditory space with variables such as pitch and volume, a three dimensional space, or the like. The only necessary factor is that the abstract space 302 have at least one dimension wherein a variable might be defined, as will be discussed in more detail hereinafter.

In this example of the inventive web interface method 300, a preliminary step will be to construct the abstract space 302 in a construct abstract space operation 304. Construction of the abstract space 302 may include the definition of the abstract space 302, itself, as well as definition and placement of objects 306 within the abstract space 302. Adjunct to the construction of the abstract space 302 will be the definition of allowable actions for input within the abstract space 302 in a define allowable actions (for input) operation 308. In the example of FIG. 5, for example, one of the allowable inputs might be to circle an object 306 with a cursor 310, as indicated by a circle path 312.

The actions just described as being a part of the web interface method will generally be preliminary to the actual usage of the system for communicating between devices 10, as previously discussed herein. It should be recognized that the remainder of the operations described herein in relation to this method will be repeated during the repeated functioning of the system for communicating between devices 10.

In a provide input operation 313, In a recognize input in abstract language operation 314, the action by the user (for example, the circling of the object 306 with the cursor 310, as in the example of FIG. 5), is recognized in machine specific format by the input device (such as the device 12 of FIG. 1). For example, this machine specific format has been referred to previously herein as the abstract language 18. The machine specific format, or abstract language 18 is then translated into the universal language in a convert abstract language to universal language operation 316. In the convert abstract language to universal language operation 36, as well is in the complementary process discussed herein, there will be numerous table look-up operations and other database like operations. These will include such things as locating translation rules, locating equivalent constructs for various protocols, maintaining associations between users, sessions, and current states, among others. While these can be done in software with good efficiency, as the size of the tables grows the use of Content Addressable Memory (“CAM”) will become advantageous. With CAM, most of these database operations can be performed in a single lookup cycle, instead of the typical multiple cycles proportional to the log of the table size of software. It would not normally be recognized that CAM would be of value in the translation process, since it is not normally considered a database intensive process.

To complete this more comprehensive description of the inventive method, in a transmit universal language operation 318, the universal language 20 is modified, as necessary, and transmitted, as over a private network, the internet, or the like, as has been previously discussed in more detail herein, and the universal language 20 is recovered in its pre-transmission form at the other end in a reconvert universal language to abstract language operation 320. In an act on universal language operation 322, action is taken based upon the prior input of the user in the provide input operation 313. As previously discussed herein, it is anticipated that this will normally be done by reconverting the universal language 20 to an abstract language 18 or 18a which is specific to the machine or type of machine which is to take the action (such as the second device 14 of FIG. 1).

According to the particular type of abstract space 302 being employed, variations, additions or substations to the operations described above might be employed. An abstract space 302 will be constructed in conformance with the intended access methods intended for that abstract space 302. For example, if a space 302 were to be constructed whereby one of a set of objects 306 or actions were to be selected by means of motion through a constrained path, then the space might be constructed by the following steps. As will be discussed in more detail hereinafter, in the example of FIG. 6, selection is made by following a predefined path to arrive at the desired selection. Deviation from the path, or exiting the path prior to arrival at the destination would result in no selection. Only complete traversal of the path would effect the selection. Again, the translation means would recognize the selection gesture predefined for this input medium and organization, and would generate a universal language “paragraph” which would indicate that the appropriate element in the object list was selected. The “paragraph” would be sent to the server which would determine what action, if any, was to be taken in response to the event. Even though the selection process of this example is significantly different from the preceding example, the same “paragraph” in the universal language 20 could result. These steps will be discussed here more specifically in relation to a second abstract space 302a example, which is shown in the drawing of FIG. 6. The steps for forming such a second abstract space 302 can be:

1. Selection of the objects 306 and action icons to be placed in the space 302a.

2. Selection of the location and orientation of each of the objects 306 in the space 302a.

3. Selection of a set of constrained paths 350 and the associated boundary representations in the abstract space 302a.

4. Association of the path(s) 350 with an object 306 or icon in the space 302a.

5. Instruction of a control means (such as the device 12) to recognize motion of the pointer (such as the cursor 310) in the abstract space 302a, and to recognize when one of the path 350 boundaries was crossed, as well as the direction of crossing—that is, if the crossing was from inside the path to outside, or from outside to inside, and the like.

6. Instruction of the control means to recognize arrival of the cursor 310 at the path 350 terminus, and then to select the associated object 306 or execute the associated action.

7. Instruction of the control means to ignore arrival at the path 350 terminus by any other path than the constrained one associated with the terminal element. In other words, ignore any arrival that includes a path boundary crossing.

8. Developing a lexicon of operations, object representations, etc. in the universal language 20 relating to the defined operations and objects from the preceding steps.

Another example of the construction of another type of abstract space (not shown) which would include auditory feedback of position in the space, and where navigation is by means of keypresses on a telephone keypad, could be constructed as follows:

1. Define the key functions. For example, 1=home (go to known starting point), 2=move up, 4=move left, 5=select current position and activate associated subspace. 6=move right, 8=move down.

2. Develop a spatial structure associated with the navigation directions, and with particular actions or functions assigned to each structure location.

3. Develop voice feedback messages to be delivered on entry to each structure location.

4. Instruct a control means to recognize keypress information, and to associate such keypresses with motion in the abstract space.

5. Instruct a control means to recognize entry into a structure location, and to produce the associated feedback message on entry.

6. Instruct a control means to perform the action associated with that location when that location is selected.

Yet another example of the construction of an abstract space might be one wherein the particular type of abstract space (not shown) would be dynamic, such that such a space changes structure, choices, and other characteristics based on previous operations performed by the user. Such a space could be constructed by:

1. Defining the initial space.

2. Defining the allowable transitions from the initial space.

3. Defining the transformations of the space resulting from each possible transition.

4. For each of the transition states, define allowable transitions and transformations resulting from each transition.

5. Continue definition until all permitted states, transitions, and transformations have been described.

6. Implement the definitions as described the previous examples, or by other means as appropriate.

7. Developing a lexicon of operations, object representations, etc. in the universal language relating to the defined operations and objects from the preceding steps.

FIG. 7 is an example of a second alternate abstract space 302b. Like several of the previous examples, the second alternate abstract space 302b is implemented on a computer screen, although it should be remembered that this is only one of many potential locations and implementations of such a space. In the second alternate abstract space 302b selections are indicated in degree by the relative position of the position of traversal where a track 356 of the cursor 310 crosses on of a plurality (two are shown in the example of FIG. 7) of indicator lines 360 which is associated with that selection. In addition to the graphic indications, additional quantitative information could be provided to indicate numeric or other value of the actual crossing point of the track 356 and each of the indicator line(s) 360. The translation means would recognize the crossings and the selection gesture predefined for this input medium and organization, and would generate a universal language 20 “paragraph” which would indicate that the appropriate selections were made and particular modifiers to the selections applied. The “paragraph” could be sent to the server which would determine what action, if any, was to be taken in response to the events, as discussed previously herein. In the example of FIG. 7, a check mark 362 is used to very that the user's input is complete.

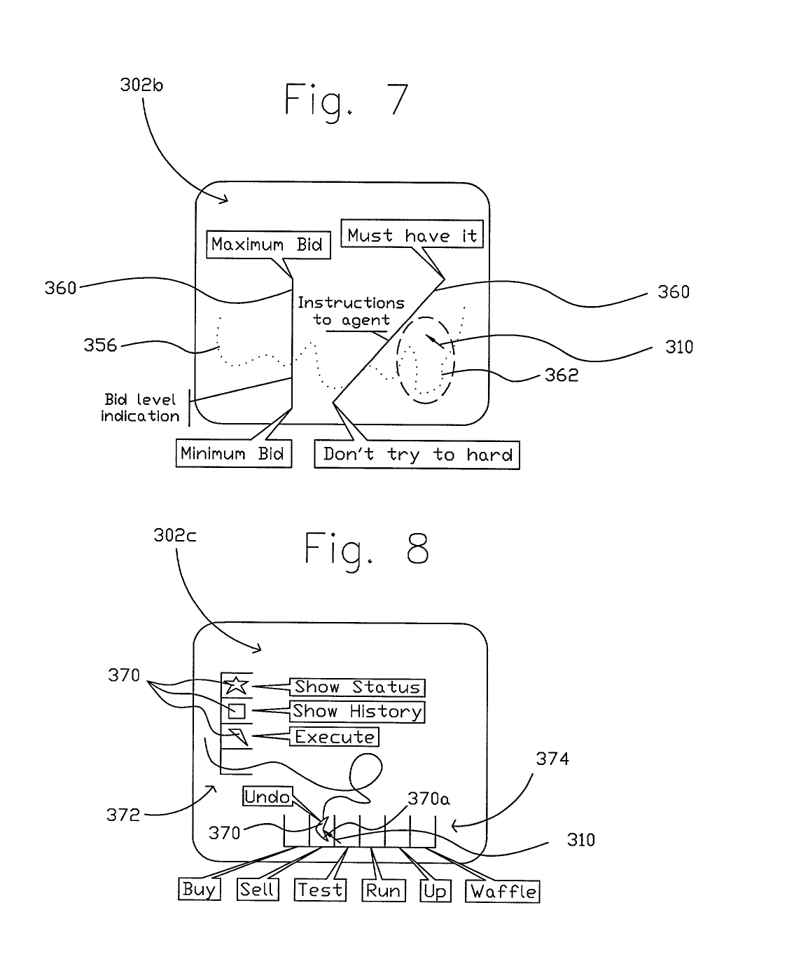

FIG. 8 is an example of a third alternate abstract space 302c. In the example of FIG. 8, a plurality (four in this present example) of action objects 370 which are located initially in a pick up area 372. In the particular example shown, an undo object 370a is picked up by moving the cursor 310 through the space of the undo object 370a area in the pickup area 372. The object 370 is then carried by the cursor 310 until it is deposited in the appropriate section of a docking area 374, or else returned to the pickup area 372. This differs from previous paradigms in that instead of an object being moved to an operator, as moving a file to a “trash can”, an operation symbol is moved to a point of execution, or to a modifier location, and does not require a “click” or “grab” operation. As discussed previously herein in relation to other examples of the invention, the translation means would recognize the selection gestures predefined for this input medium and organization, and would generate a universal language 20 “paragraph” which would indicate that the particular operation was selected, and applied to a specific item.

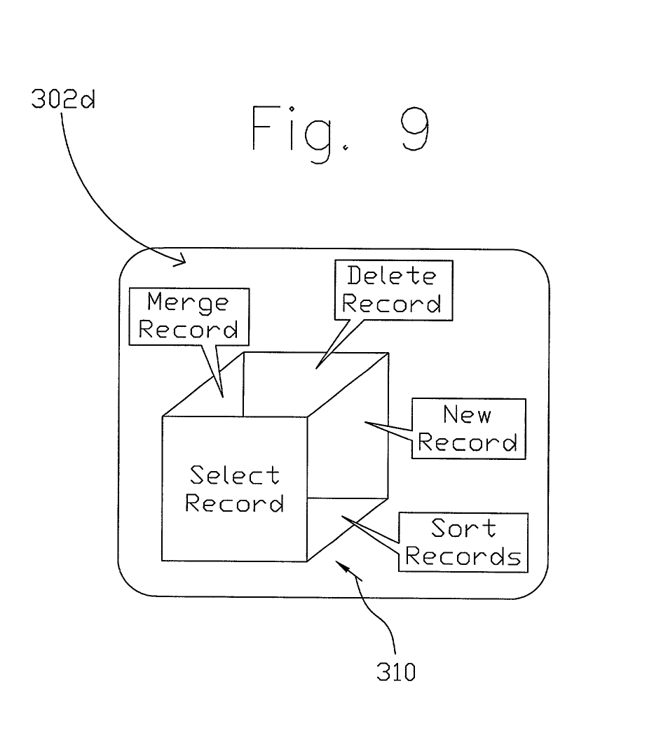

FIG. 9 is an example of a fourth alternate abstract space 302d. The fourth alternate abstract space 302d is a three dimensional cube is (shown represented in two dimensional form in the view of FIG. 9) where each face of the cube represents a particular action or selection, and initiation of that action or selection is made by “touching” the appropriate face. In actual practice a real three dimensional cube could be used or, alternatively, a two dimensional representation such as that shown in the view of FIG. 9 could be used and the “touching” could be accomplished with the cursor 310.

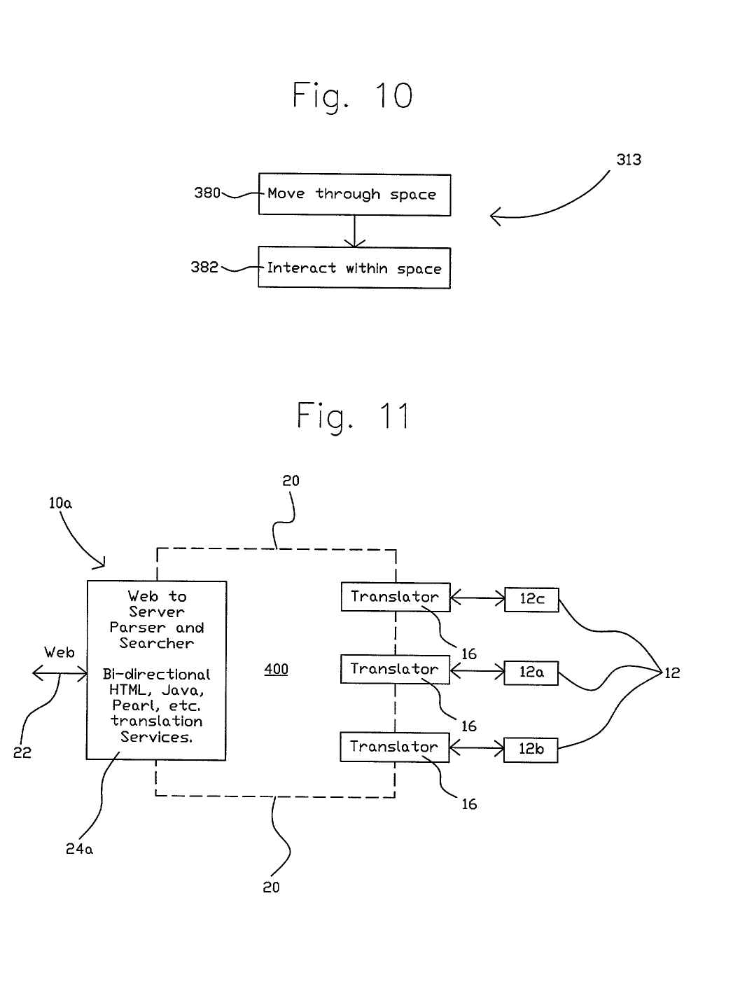

As can be appreciated in light of the above described examples, the provide input operation 313 of FIG. 4 can be accomplished in a great variety of ways. FIG. 10 is a flow diagram depicting an example of the primary substeps of the provide input operation 313. As can be seen in the view of FIG. 10, it is an aspect of the present invention that the user will move through a selected abstract space (302, 302a, 302b, 302c, or the like). Such movement will be in a controlled manner, ad through a constrained path, or the like, as described above. This controlled movement is indicated by a move through space operation 380 in diagram of FIG. 10. In an interact within space operation 382, the user will use the controlled movement to intercept or intersect objects (which, as described by way of example previously herein may be representations of physical objects, icons, action items, or the like) to indicate choices or desired operations.

Referring again to the diagrammatic representation of the system for communicating between devices 10 of FIG. 1, it should be noted that the system shown is a greatly simplified version of the invention which has been presented herein to best facilitate a discussion of the aspects of the invention previously discussed herein. However, one skilled in the art will recognize that the simple example of FIG. 1 does not fully describe the relationship of devices (such as the devices 12 and 14) which may be connected over the internet 22. Therefore, FIG. 11 is a diagrammatic representation of an alternate system for communicating between devices 10a which more fully illustrates this aspect of the invention. The basic elements of the alternate system for communicating between devices 10a are the universal language 20 which is communicated between a plurality (three, in this example) of alternate devices 12a, 12b and 12c. A plurality of the universal language translators 16 translate to and from the universal language 20 in ways appropriate to the particular device 12 or system utilizing the structure. Further, there may be a hierarchy of these systems such that each system addresses a specific universe of applications, and a higher level system links and translates lower level systems in a similar manner. A particular implementation of the system is represented in the diagram of FIG. 11. This diagram depicts an implementation of the interface which augments the current web server structure where screen based “browsers” interact with page based web sites via a web server. In this instance, the interface system would reside in the network between the user and the server. The elements of this implementation are a parser/searcher 24a, a profile manager 400, and one or more of the translators 16, as shown.

In general, the components of the system 10a will form a proxy server interface to each device 12. Conventional browser enabled devices 12 can connect through the system which would be able to present information to and from the device browser as though it were directly accessing the web 22, or it can add additional services and capabilities for improved filtering, searching, presentation, and the like.

The parser/searcher 24a component is responsible for the web interface functions, and for basic translation, interpretation, and encapsulation functions, much as described in relation to the general web interface device 24 discussed previously herein. From a web side, the parser/searcher 24a will look like a conventional screen based device which will accept HTML pages, Java applets, and other browser based inputs, and which will produce responses and outputs as though it were connected to a conventional browser.

The profile manager 400 is responsible for handling all data passing through the system 10a. In addition, it offers services to both the devices 12 and the web interface (in this example the parser/searcher 24a) for data abstraction; format, language, medium, and other translations; command interpretation and preparation, API services, and others as necessary.

As previously discussed herein, the translators 16 handle device specific functions, and translate information to and from forms most suitable for the particular device 12. Information is presented to the translator 16 and received from the translator 16 by standardized functions in the universal language 20, although each translator need not necessarily understand all potential aspects of the universal language 20, depending upon the characteristics and requirements of the device 12 attached thereto.

It should be recognized that the alternate system 10a is but one example of an indefinite plurality of such systems which will be connected to the internet 22. In practice, many such systems 10, 10a, and variations thereof, will be connected to the internet and potentially available for interaction.

As can be appreciated in light of the above descriptions, certain operations are common to nearly all transactions through the inventive systems 10, 10a. These include:

Connecting to a device (12, 14, or the like),;

identifying and activating the appropriate device translator (such as the universal language translator 16);

exchanging messages between the device translator and the profile manager 400 (where the system 10a is configured to include the profile manager 400 as described in relation to FIG. 11);

requesting a web site connection (access of a website);

exchange of messages between the website and the parser/searcher 24a (or directly between devices 12, 14, where the parser/searcher is not implemented as a separate device);

translation of messages to and from the website between the universal language 20 and the native web forms (the abstract languages 18, 18a);

exchange of messages to and from the parser/searcher 24a and the profile manager 400; and

maintenance of device state information and access information.

Various modifications may be made to the invention without altering its value or scope. For example, many other types of web interface abstract spaces and methods and modes of interaction therewith might be developed in the future. Several brief examples of such potential applications will be described in the following paragraphs. These applications are representative of applications enabled by the web interface method and/or the system for communicating between devices 10 and system for communicating between devices 200. While they represent valuable applications, they are by no means an exhaustive list of such applications. In addition to describing a particular application, they also serve as an example of a mode of use, and as such, will be representative and descriptive of any other application with an equivalent mode of use.

One such potential application would be a call center. For telephone access to the web, there are a few interactions which are difficult to perform with a limited keypad such as the 12 key pad found on most telephones. One particular operation is selection of a web site. While all web sites have a numeric designation, few users remember, or even know such designations for even their most commonly used sites. Most commonly used are the alphanumeric names such as “yahoo” or “eBay”. In order to address this aspect of web access, a particular business (operating) model is proposed where the user first places a call to an access call center. This call center can be either human agent staffed, or can use automated speech recognition, the choice depending on the particular operating and transaction services offered by the center. This call center will function much like directory information does today. It will allow the user to provide a site name for connection. The agent will locate the website, may confirm that it is the correct site, and provide connection through the universal interface system. From that point, the user can navigate through the system using the keypad and perhaps speech recognition services of the device translator, depending on the particular implementation.

The call center will obtain revenue from any of a variety of sources, including direct charge to the user, a fee to the website, advertising fees, portal fees, and others. The particular forms of revenue will depend on the business model of the particular call center. In some instances, the call center could be accessed while in an internet session to obtain assistance in matters such as selecting a new website, or other assistance as appropriate. In such a case, the device translator state information can be communicated to the call center to facilitate service of the request for assistance.

Another example of an application of the present invention is a video guide. Currently, a limited form a video guide for digital cable and satellite television systems is available from some vendors. This guide presents a selection of available programs, typically by date and time, and sometimes allows the user to select one of the programs by use of the remote control associated with the “set top box”. Additionally, the user may be presented with advertising and other information in addition to the program information. This presentation relies on a limited interaction capability between the remote control, the set top box, and the cable service provider. The interaction is limited by the bandwidth available for communication, as well as by the computer processing power available through the set top box. In the downstream direction, from the cable provider to the user, bandwidth is less restrictive, often reaching to megabits per second. The upstream side, however, is often highly restricted, typically offering a few kilobits per second or less. Also the available processing power of the set top box is limited and shared between multiple tasks. Internet access is desirable given the large number of potential users, and the convenience of preparing and distributing information, but so far, attempts to implement an effective browser in the set top box have been defeated by the above limitations.

Other approaches have attempted to replace the current set top boxes with ones of greater capability, but have encountered the economic difficulty of providing high capability units with sufficiently low cost to replace present units. The web interface method 300 offers internet capability by accepting the current device limitations, and operating within those limits to provide access within the restrictions of technology and transfer rates. A portion of the device translator function is implemented in the set top box. This portion provides basic interpretative and display functions, and can take advantage of predefined programmed or downloaded functions and displays. These functions and displays can be evoked with simple parameterized commands, reducing the amount of information which must be transferred. It can also facilitate transfer of information by use of short messages which supplant the verbose messages of the HTML based internet, while still accomplishing equivalent operations. The remainder of the device translator at the server end is cognizant of the limitations of the set top box, as well as of the functions and predefinitions and conventions for transfer. It will only convey to the set top unit that information which can be presented given the limitations of the elements involved. As more capable set top units are implemented, appropriate device translators will take advantage of those capabilities to offer more transparent internet access.

Initially, replacement of the limited menu system will be enabled, so that a viewing guide can be obtained from the web and displayed at the user site. Profile manager and Device translator processing will recognize guides which are applicable to the particular user and can appropriately annotate them for display and selection at the user site.

Still another example of an application of the invention would be an interactive video shopping/purchasing system. With the interaction capabilities described previously herein in relation to the video guide application, a number of other applications become possible. Among these are various forms of shopping and purchasing. Television is widely used for advertising and promotion, but presently a potential buyer must note a brand or a phone number and then call to place an order, or locate a vendor of the brand and purchase the item when shopping. The ability to interact through the set top box provides a significant opportunity to reduce the effort on the part of the consumer to acquire the items advertised. As an example, the user would view a channel, such as the “Home Shopping Channel”, and view images and descriptions of various goods and services offered for sale. In addition to the video information, the channel would also send purchase and related information to the set top box. Through the selection methods implemented through the Universal Interface, the user would select the item or service for purchase.

A message sent to the cable center would indicate the item and quantity selected. The cable center would have account information which would uniquely identify the user, and would provide to the vendor of the product the purchase information, as well as financial and shipping information such as a credit card number or account number for the purchase. This financial and related information would be provided to the cable service provider separately from communications via the set top box, so that security in the transaction would be preserved. The vendor would receive the ordering information from the cable vendor, eliminating the need for a separate telephone call or other purchasing event. Likewise, such purchasing capability could be added to conventional commercials so that users who had the capabilities of the present invention could be used to order the advertised items during the presentation of the commercial. Specialized channels could be developed which would offer particular goods or services through the Universal Interface capabilities. Such could include, but would not be limited to, financial services, brokerages, auto dealerships, vacation and travel services, auction and resale channels, among others.

Still another example of an application of the present invention would be telephone internet services. Once voice access to the internet is enabled, there are numerous applications which can be developed. In general, almost any internet service except that which depends exclusively on graphic information display can be provided through the telephone. With the inventive web interface method 300, the website does not have to be specifically voice or WAP enabled. Particular applications include, but are not limited to map directions and email to voicemail conversion.

Yet another application of the present invention would be direct application development. As the Universal Interface benefits become more widely recognized, developers will begin to prepare materials already translated into universal language 20 representation. This will have several advantages, including better control over final result, control over content, faster processing, and more efficient web operations. Some of the possible applications and benefits would be the presentation of search results on the universal language 20, preparation of prepackaged applications in the universal language 20, greater control of the presentation, greater control of information returned by search bots, and more specific and relevant information returned by search bots.

It will be recognized that the above list of applications is not exhaustive, and that this system enables many new uses of the web and new options for information presentation and access. It will also be recognized that there will be other operations and operating modes which will implement the web interface method 300 and the system for communicating between devices 10, and that such implementations are properly covered under the scope of this description. All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### Industrial Applicability

The inventive web interface method 300, system for communicating between devices 10 and method for communicating between devices 200 are intended to be widely used in the interface of human users with machines, and particularly with remotely located computers and computerized devices. As can be appreciated in light of the above description and examples, the invention may be implemented in any of a great number of ways. A few examples are as follows:

In order to facilitate telephone access, an intermediate facility may be provided in the form of a call center. This call center may be human mediated, or may rely on automated capabilities, but in either case will provide services to telephone based users which would be difficult to initiate via a limited keypad such as exists on a typical telephone. In such access, the user would be able to speak certain requests, commands, names, or other information, and the intermediate facility would perform the requested action, service, connection, or other activity as appropriate. This service would serve as a parallel service to the Universal Interface and would augment the device translator portion. In other mediated or unmediated operation, telephone access requires:

call reception by an appropriate point of service

requesting the universal interface service

identification of the capabilities of the device requesting service

activating an instance of the appropriate device translator

maintaining information on the state of the session (menu levels, current operation, next possible states, etc.)

translation of web originated text information into voice messages (or format translation for limited text displays)

presentation of selections to the user

interpretation of selection responses from the user

preparation of universal language messages for service requests and data transfer to and from the profile manager.

Another example of the implementation of the invention would be through cable video access. Typical cable video access will be through the cable interface unit, commonly called the set top box. This device typically has a digital processor, memory, and the ability to load and execute software obtained from the cable “head end”. In most modem units, there exists a limited ability to communicate digital information bidirectionally, even though the bulk of information is the analog television signal from the cable center to the user.

The availability of limited processing power in the user device allows implementation of a segmented device translator, where a portion of the device translator resides in the access point, and a portion resides in the user device. Since the two segments are closely linked, information can be passed between them using abbreviated command structures and prearranged protocols and formats so that the volume of data transfer can be severely truncated while still providing a high quality user experience of web access.

In this form, the set top box will typically provide the following operations, among others:

reception and interpretation of user command inputs from the front panel or remote control device

presentation of menus, lists, data entry forms, and other graphic constructs

insertion and presentation of text into predefined forms and formats

decompression and presentation of graphic information

exchange of messages with the device translator segment resident at the service point.

Since the web interface method 300, the system for communicating between devices 10 and the method for communicating between devices 200 of the present invention may be readily produced and integrated with existing computers, input output devices, data communications means and methods, and the like, and since the advantages as described herein are provided, it is expected that it will be readily accepted in the industry. For these and other reasons, it is expected that the utility and industrial applicability of the invention will be both significant in scope and long-lasting in duration. NOTICE: This correspondence chart is provided for informational purposes only. It is not a part of the official Patent Application.

### CORRESPONDENCE CHART

10 SYSTEM FOR COMMUNICATING BETWEEN DEVICES

10a ALTERNATE SYSTEM

12 FIRST DEVICE

12a FIRST ALTERNATE DEVICE

12b SECOND ALTERNATE DEVICE

12c THIRD ALTERNATE DEVICE

14 SECOND DEVICE

16 UNIVERSAL LANGUAGE TRANSLATORS

18 ABSTRACT LANGUAGE

18a SECOND ABSTRACT LANGUAGE

20 UNIVERSAL LANGUAGE

22 INTERNET

24 WEB INTERFACE DEVICES

100 COMPUTER

102 MONITOR

104 SCREEN

106 KEYBOARD

108 MOUSE

109 INTERNAL DATA STORAGE

110 EXTERNAL DATA STORAGE

112 REMOVABLE MEDIA

200 METHOD FOR COMMUNICATING BETWEEN DEVICES

202 INPUT OPERATION

204 INPUT LANGUAGE

206 CONVERT TO ABSTRACT LANGUAGE OPERATION

208 CONVERT TO UNIVERSAL LANGUAGE OPERATION

210 MODIFY UNIVERSAL LANGUAGE FOR TRANSMISSION

212 COMMUNICATED CODE

214 STRIP UNIVERSAL LANGUAGE

216 RECONVERT TO ABSTRACT LANGUAGE

218 RECEIVE OPERATION

300 WEB INTERFACE METHOD

302 ABSTRACT SPACE

302a ALTERNATE ABSTRACT SPACE

302b SECOND ALTERNATE ABSTRACT SPACE

302c THIRD ALTERNATE ABSTRACT SPACE

302d FOURTH ALTERNATE ABSTRACT SPACE

304 CONSTRUCT ABSTRACT SPACE OPERATION

306 OBJECTS

308 DEFINE ALLOWABLE ACTIONS OPERATION

310 CURSOR

312 CIRCLE PATH

313 PROVIDE INPUT

314 RECOGNIZE INPUT IN ABSTRACT LANGUAGE

316 CONVERT ABSTRACT LANGUAGE TO UNIVERSAL LANGUAGE

318 TRANSMIT UNIVERSAL LANGUAGE

320 RECONVERT UNIVERSAL LANGUAGE TO ABSTRACT LANGUAGE

322 ACT ON UNIVERSAL LANGUAGE INPUT

350 CONSTRAINED PATHS

356 TRACK (OF THE CURSOR)

360 INDICATOR LINES

362 CHECK MARK

370 ACTION OBJECTS

370a UNDO OBJECT

372 PICK UP AREA

374 DOCKING AREA

380 MOVE THROUGH SPACE

382 INTERACT WITHIN SPACE

400 PROFILE MANAGER

We claim:

1. A method for interacting with a device, comprising:
(a) providing an input at a first device;
(b) recording the input in a first language;
(c) converting the input into a second language
(d) communicating said second language;
(d) converting said second language into a third language; and
(e) providing said third language to a second device.

2. The method for interacting with a device of claim 1, wherein:
the operation of communicating said second language includes transmission of the second language over the Internet.

3. The method for interacting with a device of claim 1, wherein:
the operation of communicating said second language includes the modification of said second language such that it can be transmitted via a conventional communication medium.

4. The method for interacting with a device of claim 2, wherein:
the conventional communication medium is the Internet.

5. The method for interacting with a device of claim 1, wherein:
providing said input includes moving in an abstract space.

6. The method for interacting with a device of claim 5, wherein:
the abstract space is an image on a computer screen; and
a cursor is moved through the abstract space.

7. The method for interacting with a device of claim 5, wherein:
movement through the abstract space includes moving through a constrained path.

8. The method for interacting with a device of claim 5, wherein:
movement through the abstract space includes circling an object within the space.

9. The method for interacting with a device of claim 5, wherein:
movement through the abstract space includes moving an action icon to an object.

10. The method for interacting with a device of claim 1, wherein:
said first language and said second language are the same.

11. The method for interacting with a device of claim 1, wherein:
said second language is a device independent language.

12. A method for constructing an input method, comprising:
defining an abstract space having at least one dimension;
defining at least one object within said abstract space; and
defining allowable actions within said abstract space.

13. The method of claim 12, wherein:
said allowable actions include circling said object.

14. The method of claim 12, wherein:
said allowable actions include moving said object.

15. The method of claim 12, wherein:
said allowable actions include intersecting said object.

16. The method of claim 12, wherein:
said allowable actions include moving in relation to said object.

17. The method of claim 12, wherein:
said allowable actions include moving through said abstract space.

18. A method for providing input to a device, comprising:
moving through an abstract space.

19. The method for providing input to a device of claim 18, wherein:
said abstract space is an image on a display screen.

20. The method for providing input to a device of claim 18, wherein:
input is provided by the action of moving in a predefined manner.
